(19) United States
(12) Patent Application Publication
(10) Pub. No.: US 2025/0340495 A1
(43) Pub. Date: Nov. 6, 2025

(54) SLUDGE-DERIVED PLANT BIOSTIMULANT, AND DIRECTIONAL PREPARATION METHOD AND APPLICATION THEREOF

(71) Applicant: TONGJI UNIVERSITY, Shanghai (CN)

(72) Inventors: Xiaohu DAI, Shanghai (CN); Shuxian CHEN, Shanghai (CN); Yu HUA, Shanghai (CN)

(21) Appl. No.: 19/266,416

(22) Filed: Jul. 11, 2025

(30) Foreign Application Priority Data
Sep. 25, 2024 (CN) 202411341058.2

(51) Int. Cl. C05F 7/00; C02F 11/04; C02F 11/127; C02F 11/15

(52) U.S. Cl. CPC C05F 7/00; C02F 11/04; C02F 11/127; C02F 11/15

(57) ABSTRACT

A method for directional preparation of a sludge-derived plant biostimulant is provided, in which an activated sludge material is collected from an aeration tank of a municipal wastewater treatment plant, and subjected to ultrasonic conditioning and transformation treatment to directionally prepare a target sludge-derived plant biostimulant. The transformation treatment involves solid content adjustment and alkaline thermal hydrolysis, and for a jasmonic acid hormone, a semi-anaerobic digestion biological treatment is further required.

### CROSS-REFERENCE TO RELATED APPLICATIONS

This application claims the benefit of priority from Chinese Patent Application No. 202411341058.2, filed on Sep. 25, 2024. The content of the aforementioned application, including any intervening amendments made thereto, is incorporated herein by reference in its entirety.

### TECHNICAL FIELD

This application relates to resource recovery treatment of organic solid waste, and more particularly to a sludge-derived plant biostimulant, and a directional preparation method and application thereof.

### BACKGROUND

The sludge production from sewage treatment plants is continuously rising. As a complex and high-moisture organic solid waste, the sludge, if not properly stabilized and reduced, will cause secondary pollution to groundwater and soil due to rainwater erosion and leachate infiltration. Meanwhile, sludge is rich in carbon, nitrogen and phosphorus, and contains various bioavailable substances such as polysaccharides, amino acids and humic substances. Anaerobic digestion has been widely employed in the sludge resource recovery, which can achieve the sludge stabilization and production of high-quality gaseous fuel. However, this process is also accompanied by the generation of excessive to-be-treated digested sludge. Therefore, the development of sludge resource recovery technologies is of great significance for environmental protection and resource recycling.

Food crisis has become increasingly serious due to the population growth and frequent occurrence of extreme weather events and diseases and pests, and thus it is critical to ensure the crop yield. Although the application of inorganic fertilizers and pesticides can improve the crop yield, it often results in a decline in the crop quality and poses potential risks to human health and soil ecosystems. Therefore, it is particularly important to identify alternative resources to replace conventional fertilizers and enhance agricultural productivity. Non-toxic and environmentally-friendly plant biostimulants, including humic acids, protein hydrolysates and phytohormones, have attracted considerable attention. As a class of signaling molecules in plants, the phytohormones play an important role in regulating signal transduction pathways, alleviating internal and external stimulation, and enhancing resistance to both biotic and abiotic stresses.

It has been demonstrated that the sludge extract contains plant biostimulants with potential to enhance crop growth and improve pest resistance, making it suitable as a liquid fertilizer. The development of sludge-derived plant biostimulant production technology offers a novel approach to addressing the conflict between the rising global food demand and the environmental degradation, and also promotes the resource recovery of organic solid waste. However, the phytohormone composition in the sludge extract has still not been clearly identified, and thus fails to be effectively regulated, limiting the practical application in the crop production. Therefore, there is an urgent need to provide a method for the directional preparation of key plant hormone components through biological and chemical transformation technologies, enabling the application of an appropriate sludge-derived plant biostimulant product according to the plant physiological status.

### SUMMARY

An object of the disclosure is to provide a method for directional preparation of a sludge-derived plant biostimulant to overcome the defects in the prior art.

Technical solutions of the present disclosure are described as follows.

In a first aspect, this application provides a method for directional preparation of a sludge-derived plant biostimulant, comprising:
(1) subjecting an activated sludge material from an aeration tank of a municipal wastewater treatment plant to ultrasonic conditioning to obtain a pre-processed activated sludge material; and
(2) performing a transformation treatment on the pre-processed activated sludge material to directionally prepare a target sludge-derived plant biostimulant;
wherein the transformation treatment comprises:
(S1) when the target sludge-derived plant biostimulant is an auxin hormone, adjusting a solid content of the pre-processed activated sludge material to 5-20 wt. % to obtain a first mixture; and subjecting the first mixture to a first alkaline thermal hydrolysis and separation to obtain the auxin hormone; and
(S2) when the target sludge-derived plant biostimulant is a jasmonic acid hormone, adjusting a solid content of the pre-processed activated sludge material to 3-5 wt. % to obtain a second mixture; subjecting the second mixture to semi-anaerobic digestion biological treatment and solid-liquid separation to obtain a sludge having a solid content of 5-20 wt. %; and subjecting the sludge to a second alkaline thermal hydrolysis and separation to obtain the jasmonic acid hormone;
wherein the semi-anaerobic digestion biological treatment is performed through a step of:
subjecting the second mixture to hydrolysis and acidification in an anaerobic digestion apparatus at a temperature of 35-45° C. and a pH of 4.6-5.8 to obtain the sludge, wherein a total time of the hydrolysis and the acidification is 3-8 days;
the first alkaline thermal hydrolysis and/or the second alkaline thermal hydrolysis are/is performed in a thermal hydrolysis reactor through steps of:
adjusting the first mixture or the second mixture to pH 10-12;
heating the first mixture or the second mixture to 45-55° C. followed by holding at 45-55° C. for 8-13 min;
heating the first mixture or the second mixture to 120-200° C. followed by holding at 120-200° C. for 1-3 h; and
cooling the first mixture or the second mixture followed by separation.

In a second aspect, this application provides a sludge-derived plant biostimulant prepared by the method provided herein.

In a third aspect, this application provides a use of the sludge-derived plant biostimulant in promoting plant growth and/or enhancing plant resistance.

Compared to the prior art, the present disclosure has the following beneficial effects.

The method provided herein not only addresses the issue of large quantities of sludge solid waste generated from wastewater treatment and anaerobic digestion, but also enables the directional preparation of high-value phytohormones from such waste.

Through different treatment approaches, the sludge-derived plant biostimulants enriched in auxins, upon dilution with water, can be used as liquid fertilizers to promote the seed germination and plant development. Similarly, the sludge-derived plant biostimulants enriched in jasmonic acid, after dilution, can be used as liquid fertilizers to help plants resist biotic and abiotic stresses during growth.

In addition, the sludge-derived plant biostimulant prepared herein contains humic acids as well as exogenous nutrients such as carbon, nitrogen, phosphorus, potassium, and calcium, which contribute to maintaining homeostasis during basic physiological and metabolic processes in plants, thereby enhancing overall growth performance and stress resistance.

### BRIEF DESCRIPTION OF THE DRAWINGS

FIG. 1 is a flowchart of a method for directional preparation of a sludge-derived plant biostimulant according to Example 1 of the present disclosure;

FIG. 2 schematically shows a total content of auxin and jasmonic acid phytohormones in sample P1 before and after treatment according to Example 1 of the present disclosure;

FIG. 3 schematically shows contents of representative auxin components in sample P1 according to Example 1 of the present disclosure;

FIG. 4 schematically shows contents of representative jasmonic acid components in sample P1 according to Example 1 of the present disclosure;

FIG. 5 schematically shows a total content of auxin and jasmonic acid phytohormones in sample P3 before and after treatment according to Example 2 of the present disclosure;

FIG. 6 schematically shows contents of representative auxin components in sample P3 according to Example 2 of the present disclosure;

FIG. 7 schematically shows a total content of auxin and jasmonic acid phytohormones in sample P2 before and after treatment according to Example 1 of the present disclosure;

FIG. 8 schematically shows contents of representative auxin components in sample P2 according to Example 1 of the present disclosure; and

FIG. 9 schematically shows contents of representative jasmonic acid components in sample P2 according to Example 1 of the present disclosure.

### DETAILED DESCRIPTION OF EMBODIMENTS

The endpoints of the ranges and any values disclosed herein are not limited to the exact ranges or values. Rather, these ranges and values are intended to include values close to the recited ranges or values. For any numerical ranges disclosed, the endpoints of such ranges, intermediate values within those endpoints, as well as individual values, may be combined in any manner to form one or more new numerical ranges that are considered to be specifically disclosed herein.

An embodiment of the present disclosure provides a method for directional preparation of a sludge-derived plant biostimulant, including the following steps.

(1) An activated sludge material from an aeration tank of a municipal wastewater treatment plant is subjected to ultrasonic conditioning to obtain a pre-processed activated sludge material.

(2) A transformation treatment is performed on the pre-processed activated sludge material to directionally prepare a target sludge-derived plant biostimulant.

The transformation treatment includes the following steps.

(S1) When the target sludge-derived plant biostimulant is an auxin hormone, a solid content of the pre-processed activated sludge material is adjusted to 5-20 wt. % to obtain a first mixture. The first mixture is subjected to a first alkaline thermal hydrolysis and separation to obtain the auxin hormone.

(S2) When the target sludge-derived plant biostimulant is a jasmonic acid hormone, a solid content of the pre-processed activated sludge material is adjusted to 3-5 wt. % to obtain a second mixture. The second mixture is subjected to semi-anaerobic digestion biological treatment and solid-liquid separation to obtain a sludge having a solid content of 5-20 wt. %. The sludge is subjected to a second alkaline thermal hydrolysis and separation to obtain the jasmonic acid hormone.

The semi-anaerobic digestion biological treatment is performed through the following step. The second mixture is subjected to hydrolysis and acidification in an anaerobic digestion apparatus at a temperature of 35-45° C. and a pH of 4.6-5.8 to obtain the sludge.

In some embodiments, the activated sludge material from the aeration tank of the municipal wastewater treatment plant has a dissolved oxygen concentration of 3.5-4.5 mg/L and a chemical oxygen demand (COD) loading rate of 0.60-0.80 kg COD/m³·d.

In some embodiments, the method further includes the following step.

In step (1), before the step of ultrasonic conditioning, the activated sludge material from the aeration tank of the municipal wastewater treatment plant is subjected to settling for 24 h, and filtration through a 20-mesh sieve to remove inorganic gravel.

In some embodiments, in step (1), the ultrasonic conditioning is performed at an energy density of 0.1-0.2 W/mL for 3-6 min.

In some embodiments, the solid content of the pre-processed activated sludge material is adjusted by at least one method selected from adding water, settling and concentrating, vacuum filtration or plate-and-frame filter pressing.

In an embodiment, the method further includes the following step. The first alkaline thermal hydrolysis and/or the second alkaline thermal hydrolysis are/is performed in a thermal hydrolysis reactor through the following steps. The first mixture or the second mixture is adjusted to pH 10-12. The first mixture or the second mixture is heated to 45-55° C. and maintained at 45-55° C. for 8-13 min (low-temperature stage). The first mixture or the second mixture is heated to 120-200° C. and maintained at 120-200° C. for 1-3 h (high-temperature stage). The first mixture or the second mixture is cooled and then subjected to separation.

In some embodiments, the first mixture or the second mixture is cooled to 20-30° C.

In some embodiments, during the high-temperature stage, the first mixture or the second mixture is heated to 120-200° C. and maintained for 2 h.

In some embodiments, the pH of the first mixture or the second mixture is adjusted by addition of CaO, where the CaO is added in a weight percentage concentration of 10-15 wt. % based on a dry solid weight of the sludge in the first mixture or the second mixture.

In some embodiments, the first alkaline thermal hydrolysis and/or the second alkaline thermal hydrolysis are/is performed under stirring at a speed of 200-300 rpm, and the stirring direction is changed every 10-30 min to achieve thorough mixing.

In some embodiments, in step (S2), a total time of the hydrolysis and the acidification is 3-8 days.

In an embodiment, in step (S2), the semi-anaerobic digestion biological treatment is performed through the following steps. Nitrogen gas is purged into the anaerobic digestion apparatus (equipped with stirring function) for 2 min to establish an anaerobic condition. The second mixture is placed into the anaerobic digestion apparatus, and then subjected to hydrolysis and acidification at 35-45° C. and solid-liquid separation.

In an embodiment, the separation is performed through the following step. A product of the first alkaline thermal hydrolysis or a product of the second alkaline thermal hydrolysis is subjected to high-speed centrifugation and filtration to collect a filtrate. The high-speed centrifugation is performed at 7,000-9,000 rpm for 9-15 min, and the filtration is carried out using a membrane filter with an average pore size of 0.45 μm.

In some embodiments, the auxin hormone contains indole-3-acetic acid (IAA).

In some embodiments, the auxin hormone further contains at least one of L-tryptophan, indole, indole-3-lactic acid, and indole-3-propionic acid.

In some embodiments, a total content of auxin phytohormones in the auxin hormone is 10⁴-10⁶ μg/L

It should be noted that the total content of auxin phytohormones includes the total content of auxin phytohormones such as indole-3-acetic acid, L-tryptophan, indole, indole-3-lactic acid, and indole-3-propionic acid.

In some embodiments, the jasmonic acid hormone includes jasmonic acid. A total content of jasmonic acid phytohormones in the jasmonic acid hormone is 10³-10⁵ μg/L.

In some embodiments, the jasmonic acid hormone includes 3-oxo-2-(2-(Z)-pentenyl) cyclopentane-1-butyric acid and/or cis(+)-12-oxophytodienoic acid.

An embodiment of the present disclosure also provides a sludge-derived plant biostimulant prepared by the above method.

An embodiment of the present disclosure also provides a use of the sludge-derived plant biostimulant in promoting plant growth and/or enhancing plant resistance.

The technical solutions in the embodiments of the present disclosure will be described clearly and completely below in conjunction with the accompanying drawings.

In the following examples, unless otherwise specified, all raw materials used are commercially available.

The activated sludge material used herein was collected from an aeration tank of Shanghai Hongqiao municipal wastewater treatment plant, where a dissolved oxygen concentration of the activated sludge material is 3.5-4.5 mg/L and a COD loading rate of the activated sludge is 0.8 kg COD/m³·d.

Unless otherwise specified, a total volume of the thermal hydrolysis reactor used herein is 3 L, with a working volume of 2 L. A total volume of the anaerobic digestion apparatus is 5 L, with a working volume of 3 L.

The term “semi-anaerobic” refers to a process in which only the first half of the anaerobic digestion (i.e., the hydrolysis and acidification stages) (the whole anaerobic digestion generally requires 20-30 days) is carried out, while the second half (i.e., the subsequent acetogenesis and methanogenesis stages) is not performed, thereby enabling the accumulation of more volatile fatty acids.

### Example 1

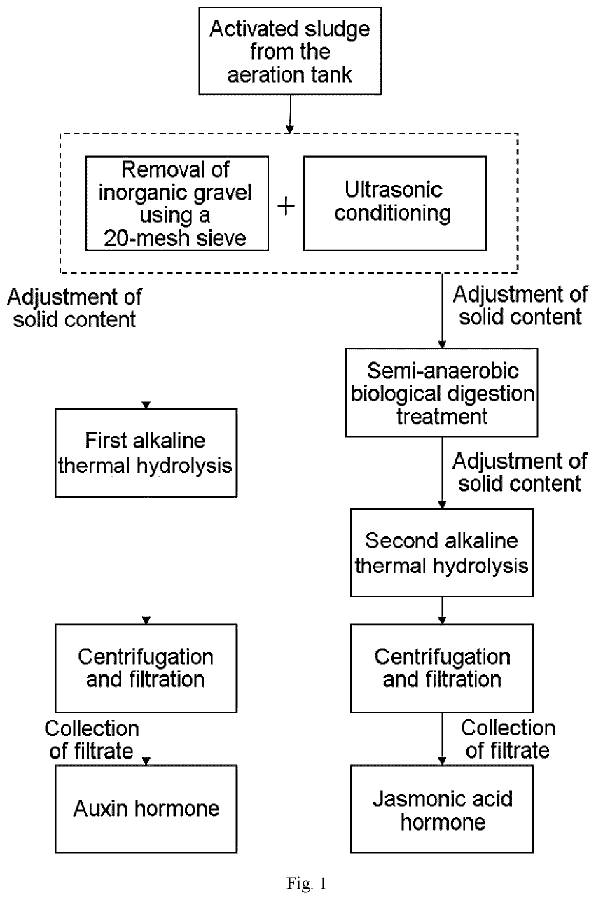

Provided herein was a method for directional preparation of a sludge-derived plant biostimulant, as shown in FIG. 1, including the following steps.

(1) An activated sludge material from the aeration tank of the municipal wastewater treatment plant was settled for 24 h and then filtered through a 20-mesh sieve to remove inorganic gravel. Ultrasonic conditioning was performed on the activated sludge material at an energy density of 0.1 W/mL for 3 min to obtain a pre-processed activated sludge material.

(2) A transformation treatment was performed on the pre-processed activated sludge material to directionally prepare a target sludge-derived plant biostimulant.

The transformation treatment included the following steps.

(S1) When the target sludge-derived plant biostimulant was an auxin hormone, a solid content of the pre-processed activated sludge material was adjusted to 5 wt. % to obtain a first mixture. The first mixture was adjusted to pH 12 by addition of 7.5 g of CaO. Then, the first mixture was transferred into the thermal hydrolysis reactor and stirred at 200 rpm with the stirring direction reversed every 20 min. The resulting mixture was heated to 50° C. and maintained at 50° C. for 10 min (low-temperature stage), then further heated to 120° C. and maintained at 120° C. for 2 h (high-temperature stage) to carry out a first alkaline thermal hydrolysis. The reaction mixture was cooled to 25° C., centrifuged at 8000 rpm for 10 min, and filtered using a membrane filter with an average pore size of 0.45 μm. The filtrate was collected to obtain the auxin hormone, designated as sample P1.

(S2) When the target sludge-derived plant biostimulant was a jasmonic acid hormone, a solid content of the pre-processed activated sludge material was adjusted to 3.12 wt. % to obtain a second mixture. The second mixture was transferred into the anaerobic digestion apparatus (equipped with stirring). Nitrogen gas was purged into the anaerobic digestion apparatus for 2 min to establish an anaerobic condition. The second mixture was then subjected to hydrolysis and acidification at 37° C. for 8 days to carry out semi-anaerobic biological digestion treatment, followed by solid-liquid separation to obtain a sludge with a solid content of 7.8 wt. %. The sludge was adjusted to pH 12 by addition of CaO.

The resulting sludge was transferred into the thermal hydrolysis reactor and stirred at 200 rpm with the stirring direction reversed every 20 min. The resulting sludge was heated to 50° C. and maintained at 50° C. for 10 min (low-temperature stage), then further heated to 120° C. and maintained at 120° C. for 2 h (high-temperature stage) to perform a second alkaline thermal hydrolysis. The reaction mixture was cooled to 25° C., centrifuged at 8000 rpm for 10 min, and filtered using the membrane filter with the average pore size of 0.45 μm. The filtrate was collected to obtain the jasmonic acid hormone, designated as sample P2.

### Example 2

Provided herein was a method for directional preparation of a sludge-derived plant biostimulant, including the following steps.

(1) An activated sludge material from the aeration tank of the municipal wastewater treatment plant was settled for 24 h and then filtered through a 20-mesh sieve to remove inorganic gravel. Ultrasonic conditioning was performed on the activated sludge material at an energy density of 0.15 W/mL for 6 min to obtain a pre-processed activated sludge material.

(2) A transformation treatment was performed on the pre-processed activated sludge material to directionally prepare a target sludge-derived plant biostimulant. The transformation treatment included the following steps.

(S1) When the target sludge-derived plant biostimulant was an auxin hormone, a solid content of the pre-processed activated sludge material was adjusted to 14 wt. % using a plate-and-frame filter press to obtain a first mixture. The first mixture was adjusted to pH 12 by addition of CaO. The first mixture was transferred into the thermal hydrolysis reactor and stirred at 200 rpm, with the stirring direction reversed every 20 min. The resulting mixture was heated to 50° C. and maintained at 50° C. for 10 min (low-temperature stage), then further heated to 160° C. and maintained at 160° C. for 2 h (high-temperature stage) to carry out a first alkaline thermal hydrolysis. The reaction mixture was cooled to 25° C., centrifuged at 8000 rpm for 10 min, and filtered using a membrane filter with an average pore size of 0.45 μm. The filtrate was collected to obtain the auxin hormone, designated as sample P3.

### Example 3

Provided herein was a method for directional preparation of a sludge-derived plant biostimulant, performed in a manner similar to Example 1 except that the low-temperature holding step in step (2) was omitted. The method included the following steps.

(2) A transformation treatment was performed on the pre-processed activated sludge material to directionally prepare a target sludge-derived plant biostimulant.

The transformation treatment included the following steps.

(S1) When the target sludge-derived plant biostimulant was an auxin hormone, a solid content of the pre-processed activated sludge material was adjusted to 5 wt. % to obtain a first mixture.

The first mixture was adjusted to pH 12 by addition of 7.5 g of CaO. The first mixture was transferred into the thermal hydrolysis reactor and stirred at 200 rpm, with the stirring direction reversed every 20 min. The resulting mixture was heated to 120° C. and maintained at 120° C. for 2 h to perform a first alkaline thermal hydrolysis. The reaction mixture was cooled to 25° C., centrifuged at 8000 rpm for 10 min, and filtered through a membrane filter with an average pore size of 0.45 μm. The filtrate was collected to obtain the auxin hormone, designated as sample P4.

(S2) When the target sludge-derived plant biostimulant was a jasmonic acid hormone, a solid content of the pre-processed activated sludge material was adjusted to 3.12 wt. % to obtain a second mixture.

The second mixture was then transferred into the anaerobic digestion apparatus (equipped with stirring function). Nitrogen gas was purged into the anaerobic digestion apparatus for 2 min to establish an anaerobic condition. The second mixture was then subjected to hydrolysis and acidification at 37° C. for 8 days to carry out semi-anaerobic biological digestion treatment, followed by solid-liquid separation to obtain a sludge with a solid content of 7.8 wt. %. The sludge was adjusted to pH 12 by addition of CaO. The resulting sludge was then transferred into the thermal hydrolysis reactor, and stirred at 200 rpm, with the stirring direction reversed every 20 min. The resulting sludge was heated to 120° C. and maintained at 120° C. for 2 h to perform a second alkaline thermal hydrolysis. The reaction mixture was cooled to 25° C., centrifuged at 8000 rpm for 10 min, and filtered through a membrane filter with an average pore size of 0.45 μm. The filtrate was collected to obtain the jasmonic acid hormone, which was designated as sample P5.

### Comparative Example 1

Provided herein was a method for directional preparation of a sludge-derived plant biostimulant, performed in a manner similar to Example 1 except that no ultrasonic conditioning was performed in step (1). The method included the following steps.

(1) The activated sludge material from the aeration tank of the municipal wastewater treatment plant was settled for 24 h, and then filtered through a 20-mesh sieve to remove inorganic gravel to obtain a pre-processed activated sludge material.

Ultimately, an auxin hormone (designated as sample P6) and a jasmonic acid hormone (designated as sample P7) were obtained.

### Test Example 1

A component quantification analysis of the auxin hormones prepared in the above Examples was performed using a highly-sensitive Liquid Chromatography-Tandem Mass Spectrometry (LC-MS/MS) platform with reference to a self-built database. The results were as follows.

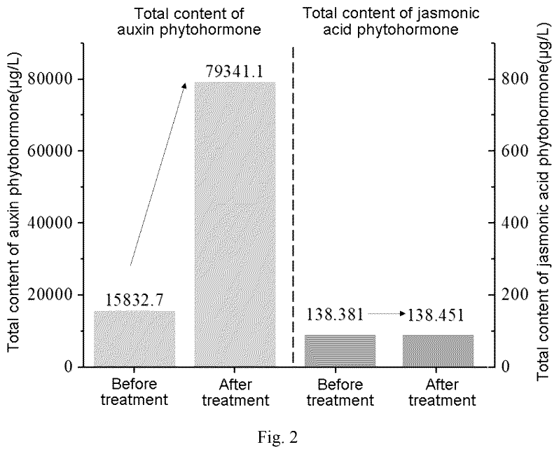

As shown in FIG. 2, compared to the untreated first mixture in Example 1, a total content of auxin phytohormones in sample P1 significantly increased from 15,832.70 μg/L to 79,341.10 μg/L, while a total content of jasmonic acid phytohormones did not show a significant change, indicating that the method provided herein successfully prepared auxin hormones.

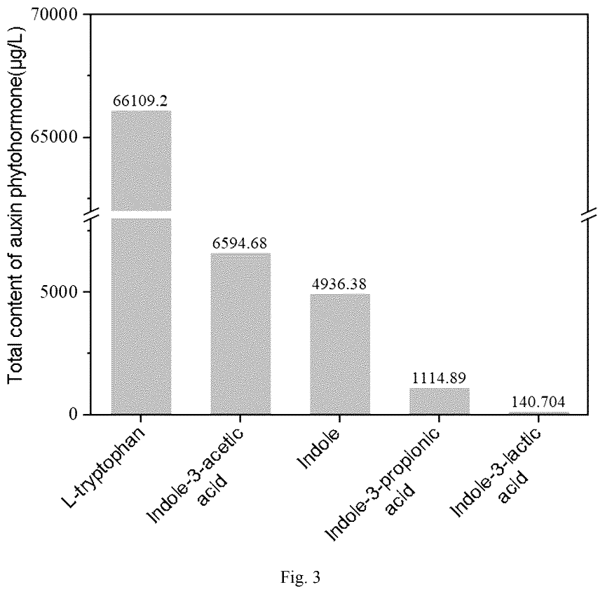

In sample P1, among the 17 detected auxins, the contents in descending order were: L-tryptophan, indole-3-acetic acid, indole, indole-3-propionic acid, indole-3-lactic acid, indole-3-carboxaldehyde, oxindole-3-acetic acid, indole-3-carboxylic acid, tryptamine, indole-3-acrylic acid, indole-3-acetyl-leucine, N-(3-indoleacetyl)-L-phenylalanine, indole-3-acetyl-valine, indole-3-acetyl-tryptophan, 3-indoleacetamide, methyl indole-3-acetate, and indole-3-acetyl-glycine. As shown in FIG. 3, in sample P1, a content of L-tryptophan was 66,109.20 μg/L, a content of indole-3-acetic acid was 6,594.68 μg/L, a content of indole was 4,936.38 μg/L, a content of indole-3-propionic acid was 1,114.89 μg/L, and a content of indole-3-lactic acid was 140.70 μg/L.

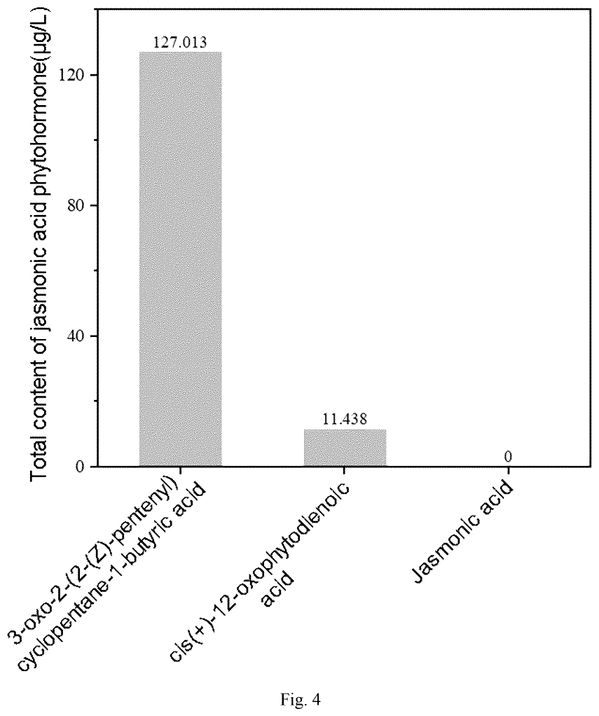

In addition, the total content of jasmonic acid phytohormones detected in sample P1 was less than 150 μg/L, including 3-oxo-2-(2-(Z)-pentenyl) cyclopentane-1-butyric acid and/or cis(+)-12-oxophytodienoic acid. As shown in FIG. 4, a content of 3-oxo-2-(2-(Z)-pentenyl) cyclopentane-1-butyric acid in sample P1 was 127.01 μg/L, and a content of cis(+)-12-oxophytodienoic acid was 11.44 μg/L.

Moreover, the obtained filtrate contained 1.05 g/L of total dissolved nitrogen, 1.30 g/L of humic acid, and 2.43 g/L of protein. In actual agricultural applications, when diluted with water at a volume ratio of 1:30, sample P1 could be used as a foliar fertilizer to promote plant growth.

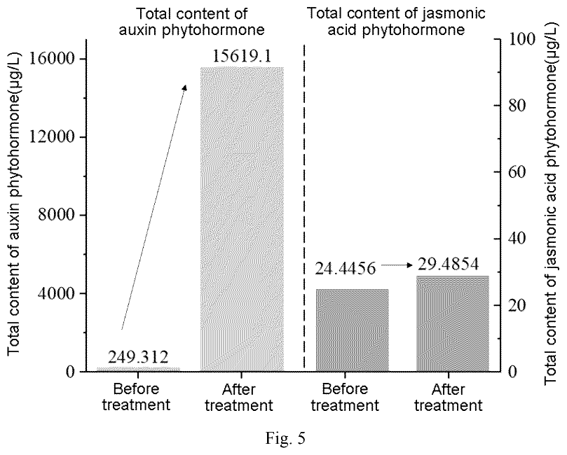

For sample P3, a total of 22 types of auxins were detected. As shown in FIG. 5, compared with the untreated first mixture in Example 2, a total content of auxin phytohormones in sample P3 increased significantly from 249.31 μg/L to 15,619.14 μg/L, while a total content of jasmonic acid phytohormones showed little change before and after treatment, indicating that auxin hormones were successfully prepared by the described method.

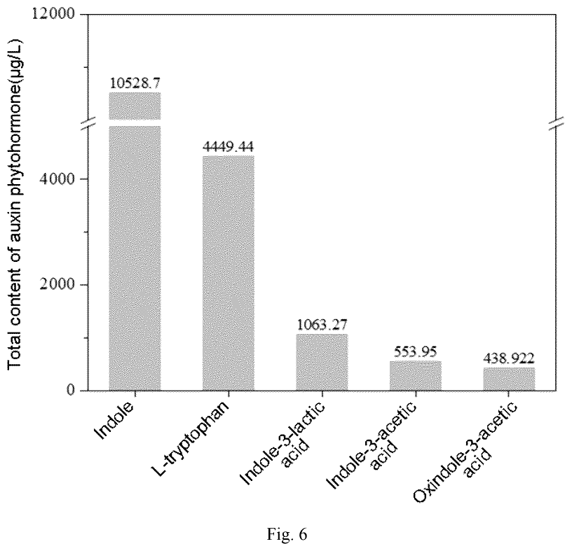

Among the auxins detected in sample P3, the components ranked in descending order of content were: indole, L-tryptophan, indole-3-lactic acid, indole-3-acetic acid, oxindole-3-acetic acid, indole-3-carboxaldehyde, tryptamine, indole-3-propionic acid, indole-3-acrylic acid, indole-3-carboxylic acid, indole-3-acetyl-aspartic acid, N-(3-indoleacetyl)-L-alanine, indole-3-butyric acid, indole-3-acetyl-leucine, indole-3-acetyl-glutamic acid dimethyl ester, methyl indole-3-acetate, indole-3-acetyl-glutamic acid, 3-indoleacetamide, N-(3-indoleacetyl)-L-phenylalanine, indole-3-acetonitrile, indole-3-acetyl-tryptophan, and indole-3-acetyl-phenylalanine methyl ester. As illustrated in FIG. 6, the primary auxins detected in sample P3 included indole (10,528.71 μg/L), L-tryptophan (10,528.74 μg/L), indole-3-lactic acid (4,449.44 μg/L), indole-3-acetic acid (1,063.27 μg/L), and oxindole-3-acetic acid (553.95 μg/L).

In addition, sample P3 also contained 5.92 g/L of dissolved total nitrogen, 7.98 g/L of humic acid, 13.68 g/L of protein, 0.33 g/L of total potassium, and 0.38 g/L of total phosphorus. When diluted with water at a volume ratio of 1:20, the sample P3 solution was applicable as a foliar fertilizer to promote plant growth.

Compared to the untreated first mixture in Example 3, a total content of auxin phytohormones in sample P4 increased from 13,354.40 μg/L to 27,864.80 μg/L, while a total content of jasmonic acid phytohormones decreased, indicating that the method described herein successfully prepared the auxin hormones.

Among the 15 auxins detected in sample P4, the compounds were ranked in descending order of concentration as follows: L-tryptophan, indole, indole-3-acetic acid, indole-3-carboxaldehyde, indole-3-lactic acid, oxindole-3-acetic acid, tryptamine, indole-3-carboxylic acid, indole-3-propionic acid, N-(3-indoleacetyl)-L-alanine, 3-indoleacetamide, indole-3-acetyl-aspartic acid, indole-3-acetyl-leucine, indole-3-acetonitrile, and N-(3-indoleacetyl)-L-phenylalanine. The concentrations of the top four compounds were 24,531.80 μg/L for L-tryptophan, 2,740.10 μg/L for indole, 253.50 μg/L for indole-3-acetic acid, and 113.50 μg/L for indole-3-carboxaldehyde. The remaining 11 compounds were all detected at concentrations below 100 μg/L.

In sample P4, a total content of four detected jasmonate compounds was 77.60 μg/L, including 12-hydroxyjasmonic acid (29.50 μg/L), cis(+)-12-oxophytodienoic acid (27.10 μg/L), dihydrojasmonic acid (18.70 μg/L), and jasmonic acid (2.40 μg/L).

Additionally, the resulting filtrate contained 0.73 g/L of dissolved total nitrogen, 3.98 g/L of humic acid, and 8.32 g/L of protein. In practical plant applications, sample P4 could be diluted with water at a volume ratio of 1:15 and used as a foliar fertilizer to promote plant growth.

Compared to the untreated first mixture in Comparative Example 1, a total content of auxin phytohormones in sample P6 increased only slightly, from 12,974.60 μg/L to 19,846.40 μg/L, indicating that the method provided herein did not effectively produce auxins and had limited practical application value.

A total of 15 auxins were identified in sample P6. Ranked by concentration from highest to lowest, the detected compounds were L-tryptophan, indole, tryptamine, indole-3-acetic acid, indole-3-carboxaldehyde, indole-3-carboxylic acid, indole-3-lactic acid, oxindole-3-acetic acid, indole-3-propionic acid, N-(3-indoleacetyl)-L-alanine, 3-indoleacetamide, indole-3-acetyl-aspartic acid, ndole-3-acetyl-leucine, indole-3-acetonitrile, and N-(3-indoleacetyl)-L-phenylalanine. Among them, the concentrations of the top four compounds were L-tryptophan (17,369.80 μg/L), indole (2,049.50 μg/L), tryptamine (254.00 μg/L), and indole-3-acetic acid (173.10 μg/L).

### Test Example 2

The components of jasmonic acid hormones prepared in the above Examples were quantitatively analyzed using a high-sensitivity LC-MS/MS platform, with reference to a self-built database. The results were as follows.

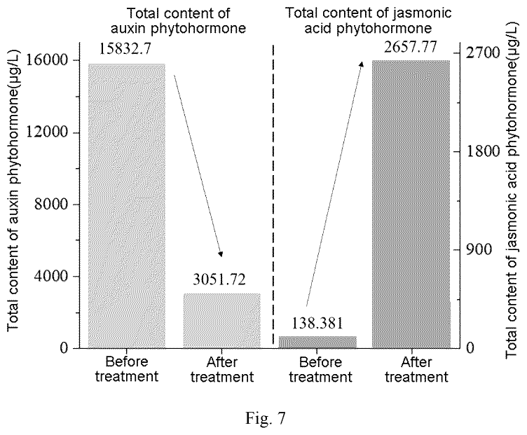

For sample P2, a total of 14 auxins and 3 jasmonic acids were detected. As shown in FIG. 7, compared with the untreated second mixture from Example 1, a total content of jasmonic acid phytohormones in sample P2 significantly increased from 138.38 μg/L to 2,657.77 μg/L, while a total content of auxin phytohormones decreased. Compared with sample P1, both the variety and content of jasmonic acids in sample P2 were notably enhanced, indicating that the method provided herein effectively produced jasmonate-type hormones.

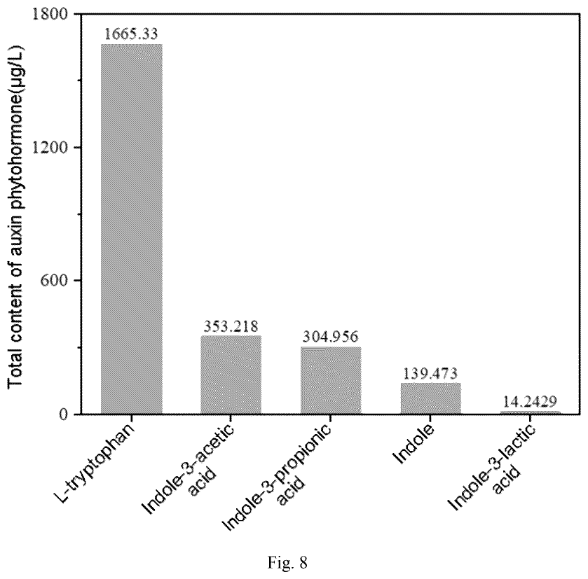

As illustrated in FIG. 8, the concentrations of auxins detected in sample P2 included 1,665.33 μg/L of L-tryptophan, 353.22 μg/L of indole-3-acetic acid, 304.96 μg/L of indole-3-propionic acid, 139.47 μg/L of indole, and 14.24 μg/L of indole-3-lactic acid.

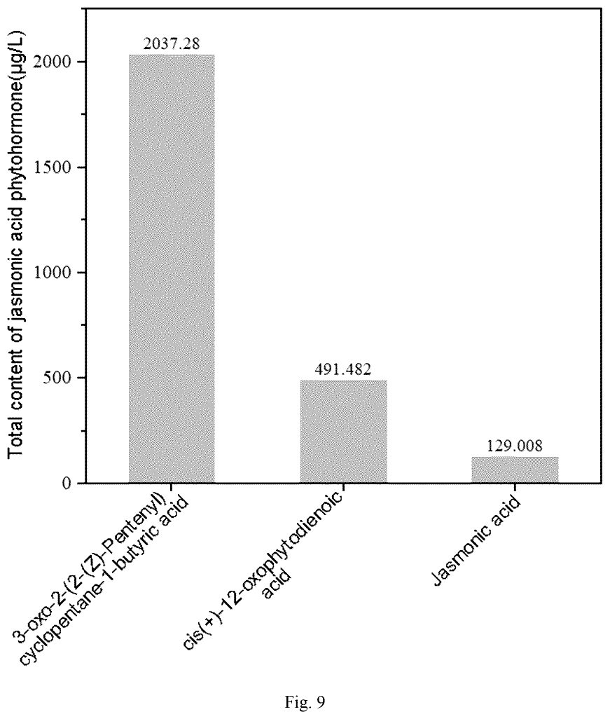

In sample P2, a total concentration of jasmonic acid phytohormones exceeded 2,600 μg/L and included 3-oxo-2-(2-(Z)-pentenyl) cyclopentane-1-butyric acid, cis(+)-12-oxophytodienoic acid and jasmonic acid. As shown in FIG. 9, the concentrations were 2,037.28 μg/L for 3-oxo-2-(2-(Z)-pentenyl) cyclopentane-1-butyric acid, 491.48 μg/L for cis(+)-12-oxophytodienoic acid, and 129.01 μg/L for jasmonic acid.

In addition, sample P2 contained 2.89 g/L of total dissolved nitrogen, 1.47 g/L of humic acid, and 1.23 g/L of protein. When diluted with water at a volume ratio of 1:20, sample P2 was applicable as a foliar fertilizer with pest-resistance-promoting effects in practical plant applications.

For sample P5, a total of 13 types of auxins and 3 types of jasmonic acid phytohormones were detected. Compared with the untreated second mixture of Example 3, a total content of jasmonic acid phytohormones in sample P5 significantly increased from 203.38 μg/L to 1,465.70 μg/L, while a total content of auxin phytohormones decreased. Compared to sample P4, sample P5 exhibited a notable improvement in the total content of jasmonic acid phytohormones, indicating that the described method effectively produced jasmonic acid hormones.

In sample P5, the quantified auxin concentrations were as follows: L-tryptophan at 2,043.30 μg/L, indole at 539.47 μg/L, indole-3-acetic acid at 383.60 μg/L, indole-3-propionic acid at 222.50 μg/L, and indole-3-carboxaldehyde at 94.24 μg/L.

The detected jasmonic acid phytohormones in sample P5 included 3-oxo-2-(2-(Z)-pentenyl) cyclopentane-1-butyric acid (1,207.50 μg/L), cis(+)-12-oxophytodienoic acid (209.40 μg/L) acid and jasmonic acid (48.80 μg/L).

In addition, sample P5 contained 1.89 g/L of total dissolved nitrogen, 5.98 g/L of humic acid, and 4.91 g/L of protein. In actual agricultural application, P5 could be used as a foliar fertilizer for pest resistance when diluted with water at a volume ratio of 1:10.

Compared with the untreated second mixture in Comparative Example 1, a total content of jasmonic acid phytohormones in sample P7 increased only slightly, from 157.40 μg/L to 318.56 μg/L, indicating that the described method exhibited limited practical value in producing jasmonic acid hormones.

In sample P7, three jasmonic acid hormones were detected, including 3-oxo-2-(2-(Z)-pentenyl) cyclopentane-1-butyric (263.64 μg/L), cis(+)-12-oxophytodienoic acid (33.67 μg/L), and jasmonic acid (21.25 μg/L).

Based on the above results, it was demonstrated that the method of the present disclosure not only addressed the issue of large volumes of sludge solid waste generated after sewage and anaerobic digestion treatment, but also enabled the directional and efficient preparation of high-value sludge-derived plant biostimulants. Moreover, different types of sludge-derived plant biostimulants could be selectively applied depending on the condition of the plants to promote growth or enhance resistance against external stressors.

Described embodiments are merely illustrative, and are not intended to limit the scope of the present disclosure. It should be understood that various modifications, changes and replacements made by those skilled in the art without departing from the spirit of the disclosure shall fall within the scope of the present disclosure defined by the appended claims.

What is claimed is:

1. A method for directional preparation of a sludge-derived plant biostimulant, comprising:
(1) subjecting an activated sludge material from an aeration tank of a municipal wastewater treatment plant to ultrasonic conditioning to obtain a pre-processed activated sludge material; and
(2) performing a transformation treatment on the pre-processed activated sludge material to directionally prepare a target sludge-derived plant biostimulant;
wherein the transformation treatment comprises:
(S1) when the target sludge-derived plant biostimulant is an auxin hormone, adjusting a solid content of the pre-processed sludge material to 5-20 wt. % to obtain a first mixture; and subjecting the first mixture to a first alkaline thermal hydrolysis and separation to obtain the auxin hormone; and
(S2) when the target sludge-derived plant biostimulant is a jasmonic acid hormone, adjusting a solid content of the pre-processed sludge material to 3-5 wt. % to obtain a second mixture; subjecting the second mixture to semi-anaerobic digestion biological treatment and solid-liquid separation to obtain a sludge having a solid content of 5-20 wt. %; and subjecting the sludge to a second alkaline thermal hydrolysis and separation to obtain the jasmonic acid hormone;
wherein the semi-anaerobic digestion biological treatment is performed through a step of:
subjecting the second mixture to hydrolysis and acidification in an anaerobic digestion apparatus at a temperature of 35-45° C. and a pH of 4.6-5.8 to obtain the sludge, wherein a total time of the hydrolysis and the acidification is 3-8 days; and
the first alkaline thermal hydrolysis and/or the second alkaline thermal hydrolysis are/is performed in a thermal hydrolysis reactor through steps of:
adjusting the first mixture or the second mixture to pH 10-12;
heating the first mixture or the second mixture to 45-55° C. followed by holding at 45-55° C. for 8-13 min;
heating the first mixture or the second mixture to 120-200° C. followed by holding at 120-200° C. for 1-3 h; and
cooling the first mixture or the second mixture followed by separation.

2. The method of claim 1, wherein the activated sludge material from the aeration tank of the municipal wastewater treatment plant has a dissolved oxygen concentration of 3.5-4.5 mg/L and a chemical oxygen demand (COD) loading rate of 0.60-0.80 kg COD/m³·d.

3. The method of claim 1 or 2, wherein in step (1), the ultrasonic conditioning is performed at an energy density of 0.1-0.2 W/mL for 3-6 min.

4. The method of claim 1 or 2, wherein the separation is performed through a step of:
subjecting a product of the first alkaline thermal hydrolysis or a product of the second alkaline thermal hydrolysis to centrifugation and filtration to collect a filtrate;
wherein the centrifugation is performed at 7,000-9,000 rpm for 9-15 min; and the filtration is carried out using a membrane filter with an average pore size of 0.45 μm.

5. The method of claim 1 or 2, wherein a total content of auxin phytohormones in the auxin hormone is 10⁴-10⁶ μg/L.

6. The method of claim 1 or 2, wherein the jasmonic acid hormone comprises jasmonic acid; and a total content of jasmonic acid phytohormones in the jasmonic acid hormone is 10³-10⁵ μg/L.

7. A sludge-derived plant biostimulant prepared by the method of any one of claims 1-6.

8. A use of the sludge-derived plant biostimulant of claim 7 in promoting plant growth and/or enhancing plant resistance.
